(19) United States
(12) Patent Application Publication
(10) Pub. No.: US 2008/0040047 A1
(43) Pub. Date: Feb. 14, 2008

(54) Systems and Computer Program Products for Probe Set Design

(76) Inventors: Charles F. Nelson, San Carlos, CA (US); Jing Gao, San Jose, CA (US); Amitabh Shukla, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/494,824

(22) Filed: Jul. 28, 2006

(51) Int. Cl. G06F 19/00

(52) U.S. Cl. 702/20

(57) ABSTRACT

Systems and methods for using the same to design target probes sets are provided. Also provided are computer program products for executing the subject methods.

### BACKGROUND

Biomolecular probes, such as nucleic acids and polypeptides, have become an increasingly important tool in the biotechnology industry and related fields. For a biomolecular probe to be of use in a particular binding assay, it needs to have associated with it specific information, e.g., its target binding specificity. This information is generally referred to as probe annotation.

One area in which annotated biomolecular probes are of particular use is in the generation and use of biopolymeric arrays. Biopolymeric arrays include regions of usually different sequence annotated probes arranged in a predetermined configuration on a substrate. These regions (sometimes referenced as “features”) are positioned at respective locations (“addresses”) on the substrate. The arrays, when exposed to a sample, will exhibit an observed binding pattern which can be detected upon interrogating the array. By correlating the observed binding pattern with the known locations of the annotated biopolymeric probes on the array, one can determine the presence and/or concentration of one or more probe-binding components of the sample.

### SUMMARY OF THE INVENTION

Systems and methods for using the same to design target probe sets are provided.

In certain embodiments, the invention provides a system for designing a target probe set, the system containing:
(A) a communication module containing an input manager for receiving input from a user and an output manager for communicating output to a user;
(B) a processing module containing:
   (1) a probe design manager, wherein the probe design manager is configured to:
      (a) design multiple probes specific for a target nucleic acid sequence input by a user; and
      (b) calculate a base-composition score for each of the multiple probes; and
   (2) a probe selection manager, wherein the probe selection manager is configured to select a target probe set from among the multiple probes based on:
      (a) a threshold value of the base-composition score; and
      (b) a probe distribution value;
wherein the target probe set contains 2 or more of the multiple probes.

In certain embodiments, the calculated base-composition score is based on: probe length, melting temperature (Tₘ), percent A, percent T, percent G, percent C, percent GC, number of poly X, intramolecular hybridization, cross-hybridization potential or combinations thereof.

In certain embodiments, the threshold value is provided by the user.

In certain embodiments, the threshold value is provided by an administrator of the system.

In certain embodiments, the probe distribution value is provided by the user.

In certain embodiments, the probe distribution value is provided by an administrator of the system.

In certain embodiments, the probe distribution value is based on: distance from the 3′ end of the target, distance between probes, overlap between probes, or combinations thereof.

In certain embodiments, the probe selection manager is further configured to lower the threshold value by a predetermined amount if a target probe set cannot be selected employing the probe distribution value.

In certain embodiments, the probe selection manager is further configured to prompt a user to input a lower threshold value if a target probe set cannot be selected employing the probe distribution value.

In certain embodiments, the probe selection manager is further configured to communicate to the user the target probe set.

In certain embodiments, the probe selection manager is further configured to communicate to the user the base-composition score and probe distribution of the target probe set.

In certain embodiments, the probe distribution for each probe in the target probe set is displayed graphically to the user.

In certain embodiments, the probe selection manager is configured to select more than one target probe set for a target nucleic acid sequence.

In certain embodiments, the invention provides a method of receiving a target probe set, the method including:
(a) inputting a target sequence into the system as described above; and
(b) receiving a target probe set for the target.

In certain embodiments, the method further includes inputting a threshold base-composition score value.

In certain embodiments, the method further includes lowering the threshold base-composition value in response to a prompt from the system.

In certain embodiments, the invention provides a method of selecting a target probe set, the method including:
(a) obtaining a target nucleic acid sequence;
(b) designing multiple probes specific for the target nucleic acid sequence;
(c) calculating a base-composition score for each of the multiple probes; and
(d) selecting a target probe set from among the multiple probes based on:
   (i) a threshold value of the base-composition score; and
   (ii) a probe distribution value;

wherein the target probe set contains 2 or more of the multiple probes.

In certain embodiments, the base-composition score is based on: probe length, melting temperature (Tₘ), percent A, percent T, percent G, percent C, percent GC, number of poly X, intramolecular hybridization, cross-hybridization potential or combinations thereof.

In certain embodiments, the probe distribution value is based on: distance from the 3′ end of the target, distance between probes, overlap between probes, or combinations thereof.

In certain embodiments, the method further includes lowering the threshold value if a target probe set cannot be selected employing the probe distribution value.

In certain embodiments, the method further includes communicating the target probe set to a user.

In certain embodiments, the method further includes communicating to the user the base-composition score and probe distribution of the target probe set.

In certain embodiments, the probe distribution for each probe in the target probe set is displayed graphically to the user.

In certain embodiments, the communicating is via the internet.

In certain embodiments, more than one target probe set is selected for a target nucleic acid sequence.

In certain embodiments, the invention provides a computer program product containing a computer readable storage medium having a computer program stored thereon, wherein the computer program, when loaded onto a computer, operates the computer to select a target probe set for a target nucleic acid sequence input by a user, wherein the target probe set is based on:
(a) a threshold base-composition score value; and
(b) a probe distribution value.

### BRIEF DESCRIPTIONS OF THE DRAWINGS

FIG. 1 illustrates a substrate carrying multiple arrays, such as may be fabricated by methods of the present invention.

FIG. 2 is an enlarged view of a portion of FIG. 1 showing multiple ideal spots or features.

FIG. 3 is an enlarged illustration of a portion of the substrate in FIG. 2.

FIG. 4 schematically illustrates an exemplary system of the present invention.

FIG. 5 provides a graphical representation of a probe distribution value filter of the present invention.

FIG. 6 provides a flow chart of an exemplary method of the present invention.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

By “array layout” is meant a collection of information, e.g., in the form of a file, which represents the location of probes that have been assigned to specific features of one or more array formats, e.g., a single array format or two or more array formats of an array set.

The phrase “array format” refers to a format that defines an array by feature number, feature size, Cartesian coordinates of each feature, and distance that exists between features within a given single array.

The phrase “array content information” is used to refer to any type of information/data that describes an array. Representative types of array content information include, but are not limited to: “probe-level information” and “array-level information”. By “probe-level information” is meant any information relating to the biochemical properties or descriptive characteristics of a probe. Examples include, but are not limited to: probe sequence, melting temperature (Tₘ), target gene or genes (e.g., gene name, accession number, etc.), location identifier information, information regarding cell(s) or tissue(s) in which a probe sequence is expressed and/or levels of expression, information concerning physiological responses of a cell or tissue in which the sequence is expressed (e.g., whether the cell or tissue is from a patient with a disease), chromosomal location information, copy number information, information relating to similar sequences (e.g., homologous, paralogous or orthologous sequences), frequency of the sequence in a population, information relating to polymorphic variants of the probe sequence (e.g., such as SNPs), information relating to splice variants (e.g., tissues, individuals in which such variants are expressed), demographic information relating to individual(s) in which the sequence is found, and/or other annotation information. By “array-level information” is meant information relating to the physical properties or intended use of an array. Examples include, but are not limited to: types of genes to be studied using the array, such as genes from a specific species (e.g., mouse, human), genes associated with specific tissues (e.g., liver, brain, cardiac), genes associated with specific physiological functions, (e.g., apoptosis, stress response), genes associated with disease states (e.g., cancer, cardiovascular disease), array format information, e.g., feature number, feature size, Cartesian coordinates of each feature, and distance that exists between features within a given array, etc.

A “data element” represents a property of a probe sequence, which can include the base composition of the probe sequence. Data elements can also include representations of other properties of probe sequences, such as expression levels in one or more tissues, interactions between a sequence (and/or its encoded products), and other molecules, a representation of copy number, a representation of the relationship between its activity (or lack thereof) in a cellular pathway (e.g., a signaling pathway) and a physiological response, sequence similarity to other probe sequences, a representation of its function, a representation of its modified, processed, and/or variant forms, a representation of splice variants, the locations of introns and exons, functional domains etc. A data element can be represented for example, by an alphanumeric string (e.g., representing bases), by a number, by “plus” and “minus” symbols or other symbols, by a color hue, by a word, or by another form (descriptive or nondescriptive) suitable for computation, analysis and/or processing for example, by a computer or other machine or system capable of data integration and analysis.

As used herein, the term “data structure” is intended to mean an organization of information, such as a physical or logical relationship among data elements, designed to support specific data manipulation functions, such as an algorithm. The term can include, for example, a list or other collection type of data elements that can be added, subtracted, combined or otherwise manipulated. Exemplary types of data structures include a list, linked-list, doubly linked-list, indexed list, table, matrix, queue, stack, heap, dictionary, flat file databases, relational databases, local databases, distributed databases, thin client databases and tree. The term also can include organizational structures of information that relate or correlate, for example, data elements from a plurality of data structures or other forms of data management structures. A specific example of information organized by a data structure of the invention is the association of a plurality of data elements relating to a gene, e.g., its sequence, expression level in one or more tissues, copy number, activity states (e.g., active or non-active in one or more tissues), its modified, processed and/or and/or variant forms, splice variants encoded by the gene, the locations of introns and exons, functional domains, interactions with other molecules, function, sequence similarity to other probe sequences, etc. A data structure can be a recorded form of information (such as a list) or can contain additional information (e.g., annotations) regarding the information contained therein. A data structure can include pointers or links to resources external to the data structure (e.g., such as external databases). In one aspect, a data structure is embodied in a tangible form, e.g. is stored or represented in a tangible medium (such as a computer readable medium).

The term “object” refers to a unique concrete instance of an abstract data type, a class (that is, a conceptual structure including both data and the methods to access it) whose identity is separate from that of other objects, although it can “communicate” with them via messages. In some occasions, some objects can be conceived of as a subprogram which can communicate with others by receiving or giving instructions based on its, or the others' data or methods. Data can consist of numbers, literal strings, variables, references, etc. In addition to data, an object can include methods for manipulating data. In certain instances, an object may be viewed as a region of storage. In the present invention, an object typically includes a plurality of data elements and methods for manipulating such data elements.

A “relation” or “relationship” is an interaction between multiple data elements and/or data structures and/or objects. A list of properties may be attached to a relation. Such properties may include name, type, location, etc. A relation may be expressed as a link in a network diagram. Each data element may play a specific “role” in a relation.

As used herein, an “annotation” is a comment, explanation, note, link, or metadata about a data element, data structure or object, or a collection thereof. Annotations may include pointers to external objects or external data. An annotation may optionally include information about an author who created or modified the annotation, as well as information about when that creation or modification occurred. In one embodiment, a memory comprising a plurality of data structures organized by annotation category provides a database through which information from multiple databases, public or private, may be accessed, assembled, and processed. Annotation tools include, but are not limited to, software such as BioFerret (available from Agilent Technologies, Inc., Palo Alto, Calif.), which is described in detail in application Ser. No. 10/033,823 filed Dec. 19, 2001 and titled “Domain-Specific Knowledge-Based Metasearch System and Methods of Using.” Such tools may be used to generate a list of associations between genes from scientific literature and patent publications.

As used herein an “annotation category” is a human readable string to annotate the logical type that an object comprising its plurality of data elements represents. Data structures that contain the same types and instances of data elements may be assigned identical annotations, while data structures that contain different types and instances of data elements may be assigned different annotations.

As used herein, a “probe sequence identifier” or an “identifier corresponding to a probe sequence” refers to a string of one or more characters (e.g., alphanumeric characters), symbols, images or other graphical representation(s) associated with a probe sequence comprising a probe sequence such that the identifier provides a “shorthand” designation for the sequence. In one aspect, an identifier comprises an accession number or a clone number. An identifier may comprise descriptive information. For example, an identifier may include a reference citation or a portion thereof.

The phrase “best-fit” refers to a resource allocation scheme that determines the best result in response to input data. The definition of ‘best’ may vary depending on a given set of predetermined parameters, such as sequence identity limits, signal intensity limits, cross-hybridization limits, Tₘ, base composition limits, probe length limits, distribution of bases along the length of the probe, distribution of nucleation points along the length of the probe (e.g., regions of the probe likely to participate in hybridization, secondary structure parameters, etc. In one aspect, the system considers predefined thresholds. In another aspect, the system rank-orders fit. In a further aspect, the user defines his or her own thresholds, which may or may not include system-defined thresholds.

The terms “system” and “computer-based system” refer to the hardware means, software means, and data storage means used to analyze the information of the present invention. The minimum hardware of the computer-based systems of the present invention comprises a central processing unit (CPU), input means, output means, and data storage means. As such, any convenient computer-based system may be employed in the present invention. The data storage means may comprise any manufacture comprising a recording of the present information as described above, or a memory access means that can access such a manufacture.

A “processor” references any hardware and/or software combination which will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

“Computer readable medium” as used herein refers to any storage or transmission medium that participates in providing instructions and/or data to a computer for execution and/or processing. Examples of storage media include floppy disks, magnetic tape, UBS, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer. A file may be stored in permanent memory.

With respect to computer readable media, “permanent memory” refers to memory that is permanently stored on a data storage medium. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

To “record” data, programming or other information on a computer readable medium refers to a process for storing information, using any convenient method. Any convenient data storage structure may be chosen, based on the means used to access the stored information. A variety of data processor programs and formats can be used for storage, e.g. word processing text file, database format, etc.

A “memory” or “memory unit” refers to any device which can store information for subsequent retrieval by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

In certain embodiments, a system includes hardware components which take the form of one or more platforms, e.g., in the form of servers, such that any functional elements of the system, i.e., those elements of the system that carry out specific tasks (such as managing input and output of information, processing information, etc.) of the system may be carried out by the execution of software applications on and across the one or more computer platforms represented of the system. The one or more platforms present in the subject systems may be any convenient type of computer platform, e.g., such as a server, main-frame computer, a work station, etc. Where more than one platform is present, the platforms may be connected via any convenient type of connection, e.g., cabling or other communication system including wireless systems, either networked or otherwise. Where more than one platform is present, the platforms may be co-located or they may be physically separated. Various operating systems may be employed on any of the computer platforms, where representative operating systems include Windows, MacOS, Sun Solaris, Linux, OS/400, Compaq Tru64 Unix, SGI IRIX, Siemens Reliant Unix, and others. The functional elements of system may also be implemented in accordance with a variety of software facilitators, platforms, or other convenient method.

Items of data are “linked” to one another in a memory when the same data input (for example, filename or directory name or search term) retrieves the linked items (in a same file or not) or an input of one or more of the linked items retrieves one or more of the others.

The term “monomer” as used herein refers to a chemical entity that can be covalently linked to one or more other such entities to form a polymer. Of particular interest to the present application are nucleotide “monomers” that have first and second sites (e.g., 5′ and 3′ sites) suitable for binding to other like monomers by means of standard chemical reactions (e.g., nucleophilic substitution), and a diverse element which distinguishes a particular monomer from a different monomer of the same type (e.g., a nucleotide base, etc.). In general, synthesis of nucleic acids of this type utilizes an initial substrate-bound monomer that is used as a building-block in a multi-step synthesis procedure to form a complete nucleic acid. A “biomonomer” references a single unit, which can be linked with the same or other biomonomers to form a biopolymer (e.g., a single amino acid or nucleotide with two linking groups, one or both of which may have removable protecting groups).

The terms “nucleoside” and “nucleotide” are intended to include those moieties which contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

As used herein, the term “amino acid” is intended to include not only the L, D- and nonchiral forms of naturally occurring amino acids (alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine), but also modified amino acids, amino acid analogs, and other chemical compounds which can be incorporated in conventional oligopeptide synthesis, e.g., 4-nitrophenylalanine, isoglutamic acid, isoglutamine, ε-nicotinoyl-lysine, isonipecotic acid, tetrahydroisoquinoleic acid, α-aminoisobutyric acid, sarcosine, citrulline, cysteic acid, t-butylglycine, t-butylalanine, phenylglycine, cyclohexylalanine, β-alanine, 4-aminobutyric acid, and the like.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other polynucleotides which are C-glycosides of a purine or pyrimidine base, polypeptides (proteins), polysaccharides (starches, or polysugars), and other chemical entities that contain repeating units of like chemical structure. In the practice of the instant invention, oligomers will generally comprise about 2-50 monomers, preferably about 2-20, more preferably about 3-10 monomers.

The term “polymer” means any compound that is made up of two or more monomeric units covalently bonded to each other, where the monomeric units may be the same or different, such that the polymer may be a homopolymer or a heteropolymer. Representative polymers include peptides, polysaccharides, nucleic acids and the like, where the polymers may be naturally occurring or synthetic.

A “biopolymer” is a polymer of one or more types of repeating units. Biopolymers are typically found in biological systems (although they may be made synthetically) and may include peptides or polynucleotides, as well as such compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. For example, a “biopolymer” may include DNA (including cDNA), RNA, oligonucleotides, and PNA and other polynucleotides as described in U.S. Pat. No. 5,948,902 and references cited therein (all of which are incorporated herein by reference), regardless of the source.

The term “biomolecular probe” or “probe” means any organic or biochemical molecule, group or species of interest having a particular sequence or structure. In certain embodiments, a biomolecular probe may be formed in an array on a substrate surface. Exemplary biomolecular probes include polypeptides, proteins, oligonucleotide and polynucleotides.

The term “ligand” as used herein refers to a moiety that is capable of covalently or otherwise chemically binding a compound of interest. The arrays of solid-supported ligands produced by the methods can be used in screening or separation processes, or the like, to bind a component of interest in a sample. The term “ligand” in the context of the invention may or may not be an “oligomer” as defined above. However, the term “ligand” as used herein may also refer to a compound that is “pre-synthesized” or obtained commercially, and then attached to the substrate.

The term “sample” as used herein relates to a material or mixture of materials, typically, although not necessarily, in fluid form, containing one or more components of interest.

A biomonomer fluid or biopolymer fluid refers to a liquid containing either a biomonomer or biopolymer, respectively (typically in solution).

The term “peptide” as used herein refers to any polymer compound produced by amide formation between an α-carboxyl group of one amino acid and an α-amino group of another group.

The term “oligopeptide” as used herein refers to peptides with fewer than about 10 to 20 residues, i.e., amino acid monomeric units.

The term “polypeptide” as used herein refers to peptides with more than 10 to 20 residues.

The term “protein” as used herein refers to polypeptides of specific sequence of more than about 50 residues.

The term “nucleic acid” as used herein means a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single-stranded nucleotide multimers of from about 10 up to about 200 nucleotides in length, e.g., from about 25 to about 200 nt, including from about 50 to about 175 nt, e.g. 150 nt in length

The term “polynucleotide” as used herein refers to single- or double-stranded polymers composed of nucleotide monomers of generally greater than about 100 nucleotides in length.

An “array,” or “chemical array” used interchangeably includes any one-dimensional, two-dimensional or substantially two-dimensional (as well as a three-dimensional) arrangement of addressable regions bearing a particular chemical moiety or moieties (such as ligands, e.g., biopolymers such as polynucleotide or oligonucleotide sequences (nucleic acids), polypeptides (e.g., proteins), carbohydrates, lipids, etc.) associated with that region. As such, an addressable array includes any one or two or even three-dimensional arrangement of discrete regions (or “features”) bearing particular biopolymer moieties (for example, different polynucleotide sequences) associated with that region and positioned at particular predetermined locations on the substrate (each such location being an “address”). These regions may or may not be separated by intervening spaces. In the broadest sense, the arrays of many embodiments are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, light directed synthesis fabrication processes are used. It will be appreciated though, that the interfeature areas, when present, could be of various sizes and configurations.

Each array may cover an area of less than 100 cm², or even less than 50 cm², 10 cm² or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays may be fabricated using drop deposition from pulse jets of either precursor units (such as nucleotide or amino acid monomers) in the case of in situ fabrication, or the previously obtained biomolecule, e.g., polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein.

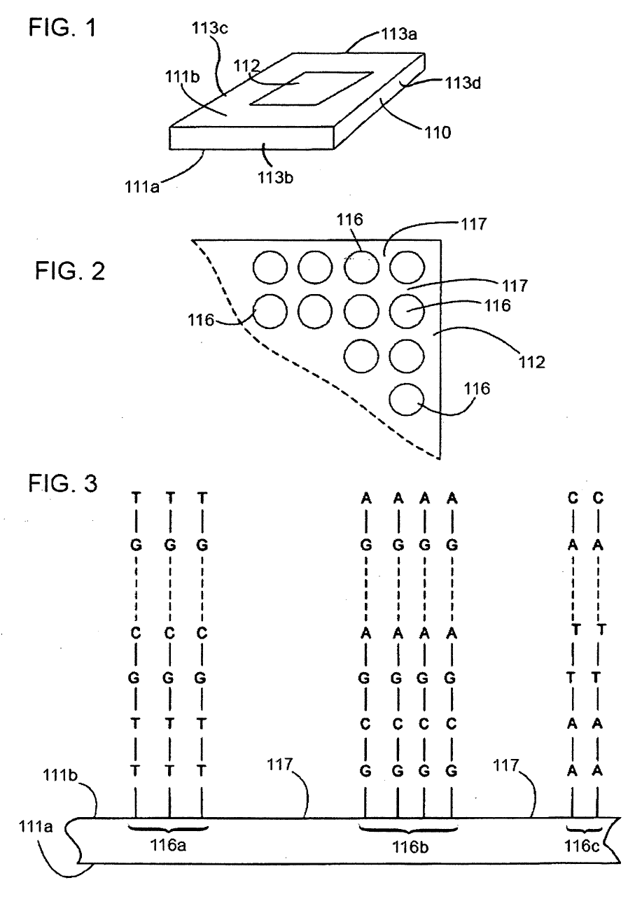

An exemplary chemical array is shown in FIGS. 1-3, where the array shown in this representative embodiment includes a contiguous planar substrate 110 carrying an array 112 disposed on a surface 111b of substrate 110. It will be appreciated though, that more than one array (any of which are the same or different) may be present on surface 111b, with or without spacing between such arrays. That is, any given substrate may carry one, two, four or more arrays disposed on a front surface of the substrate and depending on the use of the array, any or all of the arrays may be the same or different from one another and each may contain multiple spots or features. The one or more arrays 112 usually cover only a portion of the surface 111b, with regions of the rear surface 111b adjacent the opposed sides 113c, 113d and leading end 113a and trailing end 113b of slide 110, not being covered by any array 112. A second surface 111a of the slide 110 does not carry any arrays 112. Each array 112 can be designed for testing against any type of sample, whether a trial sample, reference sample, a combination of them, or a known mixture of biopolymers such as polynucleotides. Substrate 110 may be of any shape, as mentioned above.

As mentioned above, array 112 contains multiple spots or features 116 of biopolymer ligands, e.g., in the form of polynucleotides. As mentioned above, all of the features 116 may be different, or some or all could be the same. The interfeature areas 117 could be of various sizes and configurations. Each feature carries a predetermined biopolymer such as a predetermined polynucleotide (which includes the possibility of mixtures of polynucleotides). It will be understood that there may be a linker molecule (not shown) between the rear surface 111b and the first nucleotide. Any convenient linker may be used.

Substrate 110 may carry on surface 111a, an identification code, e.g., in the form of bar code (not shown) or the like printed on a substrate in the form of a paper label attached by adhesive or any convenient means. The identification code contains information relating to array 112, where such information may include, but is not limited to, an identification of array 112, i.e., layout information relating to the array(s), etc.

The substrate may be porous or non-porous. The substrate may have a planar or non-planar surface.

In those embodiments where an array includes two more features immobilized on the same surface of a solid support, the array may be referred to as addressable. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one which is to be evaluated by the other (thus, either one could be an unknown mixture of analytes, e.g., polynucleotides, to be evaluated by binding with the other).

An array “assembly” includes a substrate and at least one chemical array, e.g., on a surface thereof. Array assemblies may include one or more chemical arrays present on a surface of a device that includes a pedestal supporting a plurality of prongs, e.g., one or more chemical arrays present on a surface of one or more prongs of such a device. An assembly may include other features (such as a housing with a chamber from which the substrate sections can be removed). “Array unit” may be used interchangeably with “array assembly”.

The term “substrate” as used herein refers to a surface upon which marker molecules or probes, e.g., an array, may be adhered. Glass slides are the most common substrate for biochips, although fused silica, silicon, plastic and other materials are also suitable.

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. “Stably attached” or “stably associated with” means an item's position remains substantially constant where in certain embodiments it may mean that an item's position remains substantially constant and known.

A “web” references a long continuous piece of substrate material having a length greater than a width. For example, the web length to width ratio may be at least 5/1, 10/1, 50/1, 100/1, 200/1, or 500/1, or even at least 1000/1.

“Flexible” with reference to a substrate or substrate web, refers to a substrate that can be bent 180 degrees around a roller of less than 1.25 cm in radius. The substrate can be so bent and straightened repeatedly in either direction at least 100 times without failure (for example, cracking) or plastic deformation. This bending must be within the elastic limits of the material. The foregoing test for flexibility is performed at a temperature of 20° C.

“Rigid” refers to a material or structure which is not flexible, and is constructed such that a segment about 2.5 by 7.5 cm retains its shape and cannot be bent along any direction more than 60 degrees (and often not more than 40, 20, 10, or 5 degrees) without breaking.

The terms “hybridizing specifically to” and “specific hybridization” and “selectively hybridize to,” as used herein refer to the binding, duplexing, or hybridizing of a nucleic acid molecule preferentially to a particular nucleotide sequence under stringent conditions.

“Hybridizing” and “binding”, with respect to polynucleotides, are used interchangeably.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

“Stringent hybridization conditions” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1 M NaCI, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions sets forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions may also be employed, as appropriate.

“Contacting” means to bring or put together. As such, a first item is contacted with a second item when the two items are brought or put together, e.g., by touching them to each other.

“Depositing” means to position, place an item at a location-or otherwise cause an item to be so positioned or placed at a location. Depositing includes contacting one item with another. Depositing may be manual or automatic, e.g., “depositing” an item at a location may be accomplished by automated robotic devices.

By “remote location,” it is meant a location other than the location at which the array (or referenced item) is present and hybridization occurs (in the case of hybridization reactions). For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart.

“Communicating” information means transmitting the data representing that information as signals (e.g., electrical, optical, radio signals, and the like) over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

An array “package” may be the array plus only a substrate on which the array is deposited, although the package may include other features (such as a housing with a chamber).

A “chamber” references an enclosed volume (although a chamber may be accessible through one or more ports). It will also be appreciated that throughout the present application, that words such as “top,” “upper,” and “lower” are used in a relative sense only.

It will also be appreciated that throughout the present application, that words such as “cover”, “base” “front”, “back”, “top”, are used in a relative sense only. The word “above” used to describe the substrate and/or flow cell is meant with respect to the horizontal plane of the environment, e.g., the room, in which the substrate and/or flow cell is present, e.g., the ground or floor of such a room.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present, and, thus, the description includes structures wherein a non-hydrogen substituent is present and structures wherein a non-hydrogen substituent is not present.

### DETAILED DESCRIPTION

Systems and methods for designing a target probe set are provided. The subject systems include a communications module and a processing module, where the processing module includes: 1) a probe design manager configured to design multiple probes for a target nucleic acid sequence input by a user and calculate a base-composition score for each; and 2) a probe selection manager configured to select a target probe set from the multiple designed probes based on a threshold base-composition score value and a probe distribution value. In certain embodiments, the system is configured to iteratively select probe sets, with each probe selection iteration having an adjusted threshold base composition value. Also provided are computer program products for executing the subject methods.

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

In the event that one or more of the incorporated literature and similar materials differs from or contradicts this application, including but not limited to defined terms, term usage, described techniques, or the like, this application controls.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Aspects of the invention include systems and methods for designing a target probe set for a target nucleic acid of interest. Representative embodiments of the subject systems generally include the following components: (a) a communications module for facilitating information transfer between the system and one or more users, e.g., via a user computer, as described below; and (b) a processing module for performing one or more tasks involved in the target probe set design methods of the invention. In representative embodiments, the subject systems may be viewed as being the physical embodiment of a web portal, where the term “web portal” refers to a web site or service, e.g., as may be viewed in the form of a web page, that offers a broad array of resources and services to users via an electronic communication element, e.g., via the Internet.

In certain embodiments, the subject systems are components of an array development systems, including but not limited to those systems described in Published United States Application publication Nos. 20060116827; 20060116825 and 20060115822, as well as U.S. application Ser. Nos. 11/349,425; 11/349,398; 11/478,975; 11/479,014; and 11/478,973; the disclosures of which are herein incorporated by reference.

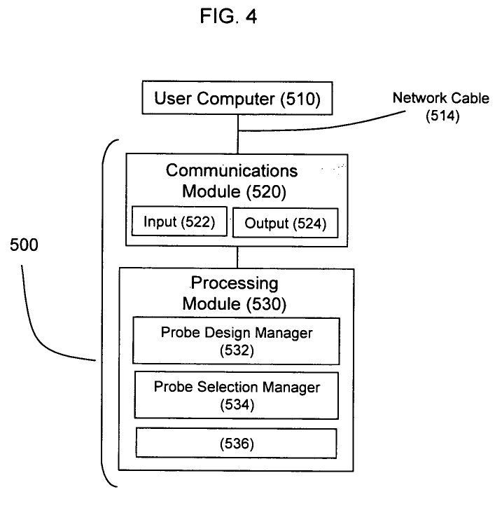

FIG. 4 provides a view of a representative probe target probe set designing system according to an embodiment of the subject invention. In FIG. 4, system 500 includes communications module 520 and processing module 530, where each module may be present on the same or different platforms, e.g., servers, as described above.

The communications module includes the input manager 522 and output manager 524 functional elements. Input manager 522 receives information from a user e.g., over the Internet. Input manager 522 processes and forwards this information to the processing module 530. These functions are implemented using any convenient method or technique. Another of the functional elements of communications module 520 is output manager 524. Output manager 524 provides information assembled by processing module 530 to a user, e.g., over the Internet. The presentation of data by the output manager may be implemented in accordance with any convenient methods or techniques. As some examples, data may include SQL, HTML or XML documents, email or other files, or data in other forms. The data may include Internet URL addresses so that a user may retrieve additional SQL, HTML, XML, or other documents or data from remote sources.

The communications module 520 may be operatively connected to a user computer 510, which provides a vehicle for a user to interact with the system 500. User computer 510, shown in FIG. 4, may be a computing device specially designed and configured to support and execute any of a multitude of different applications. Computer 510 also may be any of a variety of types of general-purpose computers such as a personal computer, network server, workstation, or other computer platform now or later developed. Computer 510 may include components such as a processor, an operating system, a graphical user interface (GUI) controller, a system memory, memory storage devices, and input-output controllers. There are many possible configurations of the components of computer 510 and some components are not listed above, such as cache memory, a data backup unit, and many other devices.

In certain embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein may be accomplished using any convenient method and techniques.

In certain embodiments, a user employs the user computer to enter information into and retrieve information from the system. As shown in FIG. 4, computer 510 is coupled via network cable 514 to the system 500. Additional computers of other users and/or administrators of the system in a local or wide-area network including an Intranet, the Internet, or any other network may also be coupled to system 500 via cable 514. It will be understood that cable 514 is merely representative of any type of network connectivity, which may involve cables, transmitters, relay stations, network servers, wireless communication devices, and many other components not shown suitable for the purpose. Via user computer 510, a user may operate a web browser served by a user-side Internet client to communicate via Internet with system 500. System 500 may similarly be in communication over Internet with other users, networks of users, and/or system administrators, as desired.

As reviewed above, the systems include various functional elements that carry out specific tasks on the platforms in response to information introduced into the system by one or more users. In FIG. 4, elements 532, and 534 and 536 represent three different functional elements of processing module 530. While three two different functional elements are shown, it is noted that the number of functional elements may be more or less, depending on the particular embodiment of the invention. Representative functional elements that may be carried out by the processing module are now reviewed in greater detail below.

In certain embodiments, the subject system includes a probe design manager 532 and probe selection manager 534 as parts of the processing module 530, which is configured to perform functions relating to designing sets of biopolymeric probes for a target input by a user. Probe design manager 532 is configured to design two or more candidate probes for a user input target sequence, and to calculate a base composition score for each of the designed candidate probes. As such, probe design manager 532 is configured to design an initial set of multiple probes specific for a target nucleic acid sequence input by a user and to calculate a base-composition score for each of the multiple probes. Probe selection manager 534 is configured to select probes from the initial multiple probe set that meet or exceed a base-composition score threshold, and then select the final probe set based on a probe distribution value of the probes. As such, the probe selection manager 534 of the system is configured to select a target probe set from among said multiple probes based on: a threshold value of the base-composition score; and a probe distribution value. Using this process, which may be iterative as described in greater detail below, the system produces a set of probes for the user input target, i.e., a target probe set, of two or more probes that are specific for the target. The member probes of the target set are probes that meet selection criteria of base composition and distribution along the target sequence.

The probe design manager may be employed to design a probe set for the target sequence. As such, a probe design manager 532 is provided that is configured to design a probe set when prompted by the user, e.g., in response to a user inputting a target sequence. The number of probes in the designed set, which may be specifically referred to as an initial probe set, may be 2 or more, such as 3 or more, e.g., 5 or more, about 10 or more, about 20 or more, etc. The probe design manager may employ any convenient probe design algorithm(s) to design a probe(s) for the target sequence. Probe design algorithms of interest include, but are not limited to: those described in U.S. Pat. Nos. 6,251,588 and 6,461,816, as well as published US Application No. 20060110744; the disclosures of which probe design algorithms are incorporated herein by reference. In certain embodiments, the probe design manager operates the design algorithm using default settings for various design parameters. In yet other embodiments, the probe design manager operates the design algorithm using one or more parameters that have been set by a user, e.g., through use of an appropriate graphical user interface, such that the probe design manager designs said at least one probe based in part on one or more parameter provided by said user.

The probe design manager 532 is also configured to evaluate each of the probes of the initial probe set to provide an initial qualification for the probes with respect to their potential performance in a hybridization assay. While the qualification may, in certain embodiments, be a qualitative evaluation, such as good, fair, poor, etc., in certain embodiments, the qualification is provided in the form of a quantitative evaluation, such as a computationally determined score. As such, in certain embodiments the probe design manager is configured to calculate at least one sequence-dependent score for at least some of, if not all of, the candidate probes in the initial probe set. The system may be configured to provide the score in any convenient way, such as by being configured to apply appropriate filters to the probe sequence and including appropriate calculation capabilities. The sequence dependent score may vary as desired, where the particular score may include one or more of the following types of score components: probe length, melting temperature (Tₘ), percent A, percent T, percent G, percent C, percent GC, number of poly X, intramolecular hybridization, cross-hybridization potential, and combinations thereof, etc. In filtering for these parameters, the system may filter for the following ranges: probe length ranging from about 15 nucleotides to about 70 nucleotides, Tₘ ranging from about 55° C. to about 87° C., percent A is ranging from about 10% to about 60%, percent T ranging from about 10% to about 60%, percent G ranging from about 10% to about 60%, percent C ranging from about 10% to about 60%, percent GC ranging from about 30% to about 70%, and number of poly X ranging from about 2 to about 8. In certain embodiments, intramolecular hybridization (e.g., formation of a hairpin loop structure in a probe) minimized. In certain embodiments, the number of nucleotides in a probe that are predicted to participate intramolecular hybridization is about 20 or fewer, including about 12 or fewer, such as about 6 or fewer, and as low as about 2 or fewer. In certain embodiments, the potential for cross-hybridization is determined by calculating a thermodynamic property of binding of the probe to a potential cross-hybridizing target (i.e., a target for which the probe was not designed) and comparing it to a corresponding thermodynamic property of binding of the probe to its intended target. For example, a probe can be considered to have low cross hybridization potential if the Tₘ of binding to the cross-hybridization target is lower than the Tₘ of binding to the intended target by about 4° C. or more, such as about 8° C. or more, including about 14° C. or more.

In certain embodiments, the system filters for one or more of the above parameters, e.g., 2 or more, 4 or more, including all of the above parameters, to provide an overall base composition score. In certain embodiments, the overall base composition score is a whole integer ranging from 1 to 5, with 1 being being and 5 being worst. After calculating a base composition score for the probes in the initial set, those probes in the set for which a score has been calculated may then be ranked according to their calculated score. As such, the system may group the probes based on their calculated score, such those probes having a calculated score of 1 are placed in a first group, those probes having a calculated score of 2 are placed in a second group, etc. It should be noted that any score scale may be employed to provide as many groupings as desired, with the above 5 integer scale being merely illustrative of the concept.

The system further includes a probe selection manager 534 which selects at least a portion of the probes from the initial target set and applies an appropriate target distribution filter to these probes to produce a final probe set for the target. In performing these tasks, the probe selection manager 534 may first select the portion of the initial probe set that is to be filtered for distribution along the target. In choosing the portion of the initial probe set, the probe selection manager may employ a threshold value which probes of the initial set must meet or exceed in order to be selected for filtering by the distribution filter. For example, where the probes of the initial set have been grouped into 5 groups based on base composition score, the selection manager may employ a threshold of 1 (best ranking) and therefore select only those probes falling in group 1 for filtering with the distribution filter. Alternatively, the probe selection manager may employ a threshold value of 2, which would then result in selection of the probes in both groups 1 and 2. The threshold value may be input by a user or an administrator of the system, as desired.

Following selection of the portion of the initial probe set, the probe selection manager then subjects this portion to a distribution filter to obtain a final set of probes for the target sequence. The probe distribution filter identifies those probes in the selection portion that have the best distribution along the target sequence based according to some predetermined measure or parameter(s). In selecting probes based on distribution, the probe distribution filter may employ a probe distribution value. In certain embodiments, the probe distribution value is based on: distance from the 3′ end of said target, distance between probes, overlap between probes, or combinations thereof. In certain embodiments, the distribution value filters for probes that hybridize to target region that is about 20 nucleotides or further from the 3′ end, such as about 100 nucleotides or further from the 3′ end, including about 1,000 nucleotides or further from the 3′ end, and including about 5,000 nucleotides or further from the 3′ end. In certain embodiments, the distribution value filters for probes that hybridize to target regions that are separated by about 500 nucleotides or fewer, such as by about 100 nucleotides or fewer, including about 25 nucleotides or fewer, and including about 10 nucleotides or fewer. In certain embodiments, the distribution value filters for probes that hybridize to target regions with minimal overlap, where any overlap is about 15 nucleotides or fewer, such as about 10 nucleotides or fewer, including about 5 nucleotides or fewer, about 2 nucleotides or fewer, and including no nucleotide overlap. The probe distribution value may be selected by the user or selected by an administrator of the system.

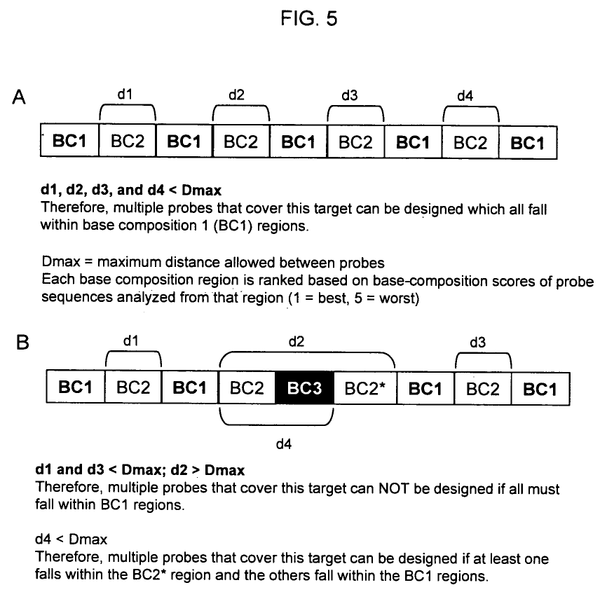

FIG. 5A provides an example of a probe selection manager that is configured to select probes that meet a base composition threshold and have a distance from each other along the target that is less than a predetermined value of Dmax. In this figure, regions of the target have been marked as BC1 and BC2 for base composition 1 and base composition 2, respectively. The distances between each BC1 region have also been marked as d1 to d4. Because all of d1 to d4 are less than Dmax, probes having a desired base composition score of 1 can be selected which meet the desired distribution value of being separated from each other along the target by a distance that does not exceed Dmax.

By applying the above distribution filter, the system is configured to provide a set of probes, i.e., two or more probes, that are chosen for the target based on both a base composition score and a distribution score.

In certain embodiments, the selection process is an iterative process. For example, where the probe selection manager cannot select a probe set that meets both the initial base composition threshold and the distribution threshold, one or both of these thresholds may be adjusted one or more times in order to obtain a set of probes for the target. For example, the probe selection manager may be configured to automatically lower the base composition threshold value by a predetermined amount, or prompt a user to input a lower threshold value, if a target probe set cannot be selected employing the initially chosen probe distribution value.

An example of a situation where an iterative process is employed is depicted in FIG. 5B. As shown in FIG. 5B, the BC1 regions of the target sequence are distributed in a manner such one portion of the target sequence has a distance between BC1 regions that exceeds the predetermined value of Dmax. Specifically, d2 exceeds Dmax and therefore BC1 scoring probes cannot be chosen for the target sequence that all meet the Dmax distribution filter. In this example, the system may then lower the base composition threshold to BC2, at least for the region of d2 (or BC2*), so that a target set that meets the desired distribution may be obtained.

Following obtainment of the probe set for the target that meets both the base composition and the distribution requirements for the target, the system then provides the set to the user. As such, the system is further configured to communicate to said user said target probe set. Along with the target probe set, where desired the system may also provide to the user the base composition scores and distribution profile for the set, such that the system is configured to communicate to the user the base-composition score and probe distribution of the target probe set. The format of communication may vary, and may be displayed graphically to the user, e.g., in a graphical format such as depicted in FIGS. 5A and 5B.

While the above description of aspects of the system and methods has been provided in terms of producing a single target probe set for a given user input target, the system may produce two or more distinct target probe sets for a given target, e.g., which meet different base composition and distribution parameters, such that the user may be provided with two or more different sets to choose from. In these embodiments, the user may then select the set or sets which best meet the user's particular needs.

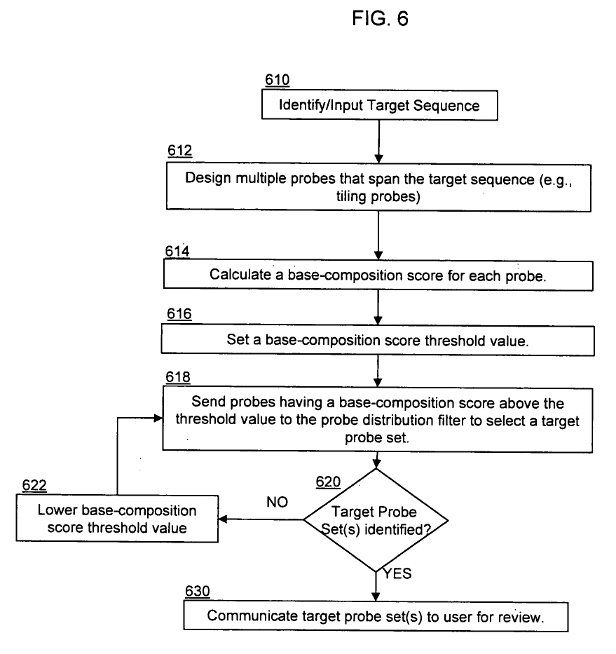

A flow diagram implementing certain aspects of the methods of the invention is provided in FIG. 6. At step 610, a user identifies and/or inputs a target sequence into the system. Next, at step 612, the system designs multiple probes that span the target sequence (e.g., tiling probes). At step 614, the system calculates a base-composition score for each probe. At step 616, the system groups the probes based by their calculated base composition score and sets a base composition score threshold value. At step 618, those probes having a score that meets or exceeds the value are then forwarded to the probe distribution filter of the probe selection manager in order to select a target probe set. At decision box 620, the system determines whether a suitable target probe set meeting both the base composition and distribution requirements has been obtained. If yes, this set is communicated to the user for review and use at step 630. If not, the process is reiterated with using a lower base composition threshold value as indicated at step 622.

Probe sets obtained according to the subject systems and methods find use in a variety of different applications, where such applications include, but are not limited to, analyte detection applications in which the presence of a particular analyte in a given sample is detected at least qualitatively, if not quantitatively. Analyte detection methods include, but are not limited to, northern blots, western blots, dot blots, southern blots, etc.

In certain embodiments, probe sets using the subject system and methods are employed in a chemical array format. Any convenient method for carrying out assays employing a chemical array(s) may be used. In certain of such methods, the sample suspected of comprising the analyte of interest is contacted with an array of immobilized probes obtained according to the subject methods under conditions sufficient for the analyte to bind to the probe. Thus, if the analyte of interest is present in the sample, it binds to the array at the site of its cognate probe and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface.

Specific analyte detection applications of interest include hybridization assays in which the nucleic acid arrays of the subject invention are employed. In these assays, a sample of target nucleic acids is first prepared, where preparation may include labeling of the target nucleic acids with a label, e.g. a member of a signal producing system. Following sample preparation, the sample is contacted with the array under hybridization conditions, whereby complexes are formed between target nucleic acids that are complementary to probe sequences attached to the array surface. The presence of hybridized complexes is then detected. Specific hybridization assays of interest which may be practiced using the subject arrays include: gene discovery assays, differential gene expression analysis assays; nucleic acid sequencing assays, and the like. Patents and patent applications describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992. Also of interest are U.S. Pat. Nos. 6,656,740; 6,613,893; 6,599,693; 6,589,739; 6,587,579; 6,420,180; 6,387,636; 6,309,875; 6,232,072; 6,221,653; and 6,180,351. ln certain embodiments, the subject methods include a step of transmitting data from at least one of the detecting and deriving steps, as described above, to a remote location.

Where the arrays are arrays of polypeptide binding agents, e.g., protein arrays, specific applications of interest include analyte detection/proteomics applications, including those described in U.S. Pat. Nos. 4,591,570; 5,171,695; 5,436,170; 5,486,452; 5,532,128 and 6,197,599 as well as published PCT application Nos. WO 99/39210; WO 00/04832; WO 00/04389; WO 00/04390; WO 00/54046; WO 00/63701; WO 01/14425 and WO 01/40803—the disclosures of which are herein incorporated by reference.

As such, in using an array having probes obtained by the system and method of the present invention, the array will typically be exposed to a sample (for example, a fluorescently labeled analyte, e.g., protein containing sample) and the array then read. Reading of the array may be accomplished by illuminating the array and reading the location and intensity of resulting fluorescence at each feature of the array to detect any binding complexes on the surface of the array. For example, a scanner may be used for this purpose which is similar to the AGILENT MICROARRAY SCANNER available from Agilent Technologies, Palo Alto, Calif. Other suitable apparatus and methods are described in U.S. Pat. Nos. 5,091,652; 5,260,578; 5,296,700; 5,324,633; 5,585,639; 5,760,951; 5,763,870; 6,084,991; 6,222,664; 6,284,465; 6,371,370 6,320,196 and 6,355,934. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample or an organism from which a sample was obtained exhibits a particular condition). The results of the reading (processed or not) may be forwarded (such as by communication) to a remote location if desired, and received there for further use (such as further processing).

In certain embodiments, the systems may include additional functionalities. For example, in certain embodiments the systems are employed in the generation of array layouts, where the probes qualified and/or redesigned by the systems are employed. In such embodiments, the array layouts generated by the subject systems can be layouts for any type of chemical array, where in certain embodiments the array layouts are layouts for biopolymeric arrays, such as nucleic acid and amino acid arrays. In certain embodiments, the layouts generated by the subject systems are for nucleic acid arrays.

In certain embodiments, the systems include an array layout functionality, e.g., as described in copending application Ser. No. 11/001,700. In certain of these embodiments, the system includes an array layout developer, where the array layout developer includes a memory having a plurality of rules relating to array layout design and is configured to develop an array layout based on the application of one or more of the rules to information that includes array request information received from a user.

In certain embodiments, the output manager further provides a user with information regarding how to purchase the identified probe set, e.g., alone or in an array. In certain embodiments, the information is provided in the form of an email. In certain embodiments, the information is provided in the form of web page content on a graphical user interface in communication with the output manager. In certain embodiments, the web page content provides a user with an option to select for purchase one or more synthesized probe sequences. In certain embodiments, the web page content includes fields for inputting customer information. In certain embodiments, the system can store the customer information in the memory. In certain embodiments, the customer information includes one or more purchase order numbers. In certain embodiments, the customer information includes one or more purchase order numbers and the system prompts a user to select a purchase order number prior to purchasing the one or more synthesized probe sequences.

In certain embodiments, in response to the purchasing, the one or more probe sequences of probe set are synthesized on an array. In certain embodiments, the methods include ordering synthesized probe(s) that include the sequences of the selected probe group. In certain embodiments, the synthesized probes are synthesized on an array. In certain embodiments, the inputting is via a graphical user interface in communication with the system.

In certain embodiments, the user may choose to obtain an array having the generated probe(s) present therein. As such, the generated probe can be included in an array layout, and an array fabricated according to the array layout that includes the generated probe. In certain embodiments, the user may specify the location of the probe in the product layout. Specifying may include choosing a particular location in a given layout, or choosing from a section of system-provided array layout options in which the probe is present at various locations. Array fabrication according to an array layout can be accomplished in a number of different ways. With respect to nucleic acid arrays in which the immobilized nucleic acids are covalently attached to the substrate surface, such arrays may be synthesized via in situ synthesis in which the nucleic acid ligand is grown on the surface of the substrate in a step-wise fashion and via deposition of the full ligand, e.g., in which a presynthesized nucleic acid/polypeptide, cDNA fragment, etc., onto the surface of the array.

Where the in situ synthesis approach is employed, conventional phosphoramidite synthesis protocols are typically used. In phosphoramidite synthesis protocols, the 3′-hydroxyl group of an initial 5′-protected nucleoside is first covalently attached to the polymer support, e.g., a planar substrate surface. Synthesis of the nucleic acid then proceeds by deprotection of the 5′-hydroxyl group of the attached nucleoside, followed by coupling of an incoming nucleoside-3′-phosphoramidite to the deprotected 5′ hydroxyl group (5′-OH). The resulting phosphite triester is finally oxidized to a phosphotriester to complete the internucleotide bond. The steps of deprotection, coupling and oxidation are repeated until a nucleic acid of the desired length and sequence is obtained. Optionally, a capping reaction may be used after the coupling and/or after the oxidation to inactivate the growing DNA chains that failed in the previous coupling step, thereby avoiding the synthesis of inaccurate sequences.

In the synthesis of nucleic acids on the surface of a substrate, reactive deoxynucleoside phosphoramidites are successively applied, in molecular amounts exceeding the molecular amounts of target hydroxyl groups of the substrate or growing oligonucleotide polymers, to specific cells of the high-density array, where they chemically bond to the target hydroxyl groups. Then, unreacted deoxynucleoside phosphoramidites from multiple cells of the high-density array are washed away, oxidation of the phosphite bonds joining the newly added deoxynucleosides to the growing oligonucleotide polymers to form phosphate bonds is carried out, and unreacted hydroxyl groups of the substrate or growing oligonucleotide polymers are chemically capped to prevent them from reacting with subsequently applied deoxynucleoside phosphoramidites. Optionally, the capping reaction may be done prior to oxidation.

With respect to actual array fabrication, in certain embodiments, the user may itself produce an array having the generated array layout. In yet other embodiments, the user may forward the array layout to a specialized array fabricator or vendor, which vendor will then fabricate the array according to the array layout.

In yet other embodiments, the system may be in communication with an array fabrication station, e.g., where the system operator is also an array vendor, such that the user may order an array directly through the system. In response to receiving an order from the user, the system will forward the array layout to a fabrication station, and the fabrication station will fabricate the array according to the forwarded array layout.

Arrays can be fabricated using drop deposition from pulsejets of either polynucleotide precursor units (such as monomers) in the case of in situ fabrication, or the previously obtained polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein. Also, instead of drop deposition methods, light directed fabrication methods may be used, as are known in the art. Interfeature areas need not be present particularly when the arrays are made by light directed synthesis protocols.

The invention also provides programming, e.g., in the form of computer program products, for use in practicing the probe annotation methods of the invention. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. Any convenient medium or storage method can be used to create a manufacture that includes a recording of the present programming/algorithms for carrying out the above described methodology.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

1. A system for designing a target probe set, said system comprising:
(A) a communication module comprising an input manager for receiving input from one or more users and an output manager for communicating output to said one or more users;
(B) a processing module comprising:
(1) a probe design manager, wherein said probe design manager is configured to:
(a) design multiple probes specific for a target nucleic acid sequence input by said one or more users; and
(b) calculate a base-composition score for each of said multiple probes; and
(2) a probe selection manager, wherein said probe selection manager is configured to:
(a) select a target probe set from said multiple probes, by:
(i) selecting a subset of probes from said multiple probes based on a threshold value of said base-composition score; and
(ii) filtering said subset of probes based on a probe distribution value;
(b) lower said threshold value by a predetermined amount and repeat step (a) if a target probe set cannot be selected employing said probe distribution value; and
(c) communicate said target probe set to said one or more users.

2. The system of claim 1, wherein said calculated base-composition score is based on: probe length, melting temperature (Tₘ), percent A, percent T, percent G, percent C, percent GC, number of poly X, intramolecular hybridization, cross-hybridization potential or combinations thereof.

3. The system of claim 1, wherein said threshold value is provided by said one or more users.

4. The system of claim 1, wherein said threshold value is provided by an administrator of said system.

5. The system of claim 1, wherein said probe distribution value is provided by said one or more users.

6. The system of claim 1, wherein said probe distribution value is provided by an administrator of said system.

7. The system of claim 1, wherein said probe distribution value is selected from: minimum distance from the 3′ end of said target nucleic acid sequence, maximum distance between probes, maximum overlap between probes, or combinations thereof.

8. (canceled)

9. The system of claim 1, wherein said probe selection manager is further configured to prompt a user to input a lower threshold value if a target probe set cannot be selected employing said probe distribution value.

10. (canceled)

11. The system of claim 1, wherein said probe selection manager is further configured to communicate to said one or more users said base-composition score for each probe in said target probe set and the distribution on said target nucleic acid sequence of the probes in said target probe set.

12. The system of claim 11, wherein said distribution on said target nucleic acid sequence for each probe in said target probe set is displayed graphically to said one or more users.

13. The system of claim 1, wherein said probe selection manager is configured to select more than one target probe set for a target nucleic acid sequence.

14. A method of receiving a target probe set, said method comprising:
(a) inputting a target sequence into the system of claim 1; and
(b) receiving a target probe set for said target.

15. The method of claim 14, wherein said method further comprises inputting a threshold base-composition score value.

16. The method of claim 15, wherein said method further comprises lowering said threshold base-composition value in response to a prompt from said system.

17. A method of selecting a target probe set, said method comprising:
(a) obtaining a target nucleic acid sequence;
(b) designing multiple probes specific for said target nucleic acid sequence;
(c) calculating a base-composition score for each of said multiple probes; and
(d) selecting a target probe set from among said multiple probes based on:
(i) a threshold value of said base-composition score; and
(ii) a probe distribution value;
wherein said target probe set comprises 2 or more of said multiple probes.

18. The method of claim 17, wherein said base-composition score is based on: probe length, melting temperature (Tₘ), percent A, percent T, percent G, percent C, percent GC, number of poly X, intramolecular hybridization, cross-hybridization potential or combinations thereof.

19. The method of claim 17, wherein said probe distribution value is based on: distance from the 3′ end of said target, distance between probes, overlap between probes, or combinations thereof.

20. The method of claim 17, wherein said method further comprises lowering said threshold value if a target probe set cannot be selected employing said probe distribution value.

21. The method of claim 17, wherein said method further comprises communicating said target probe set to a user.

22. The method of claim 21, wherein said method further comprises communicating to said user said base-composition score and probe distribution of said target probe set.

23. The method of claim 22, wherein said probe distribution for each probe in said target probe set is displayed graphically to said user.

24. The method of claim 21, wherein said communicating is via the internet.

25. The method of claim 17, wherein more than one target probe set is selected for a target nucleic acid sequence.

26. A computer program product comprising a computer readable storage medium having a computer program stored thereon, wherein said computer program, when loaded onto a computer, operates said computer to select a target probe set for a target nucleic acid sequence input by one or more users by:
(1) designing multiple probes specific for said target nucleic acid sequence;
(2) calculating a base-composition score for each of said multiple probes;
(3) selecting a target probe set comprising 2 or more of said multiple probes, wherein said selecting is based on a threshold value of said base-composition score and a probe distribution value; and
(4) lowering said threshold value by a predetermined amount and repeating said selecting step (3) if a target probe set cannot be selected employing said probe distribution value;
wherein said selected target probe set is communicated to said one or more users.
